(19) United States
(12) Patent Application Publication
(10) Pub. No.: US 2009/0316597 A1
(43) Pub. Date: Dec. 24, 2009

(54) INFORMATION PROCESSING APPARATUS

(75) Inventors: Takeshi Yasuie, Kawasaki (JP); Yuji Nomura, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/550,905

(22) Filed: Aug. 31, 2009

Related U.S. Application Data
(63) Continuation of application No. PCT/JP2007/055231, filed on Mar. 15, 2007.

(51) Int. Cl. H04L 12/26

(52) U.S. Cl. 370/252

(57) ABSTRACT

An information processing apparatus performs a communication in a communication network using packets. The communication network includes a relaying device having a function of acquiring traffic information of a packet that the relaying device relays. The information processing apparatus includes a transmission unit configured to transmit a packet to a specific node as a communication target; and a node position determining unit configured to determine a position of the specific node by acquiring the traffic information from the relaying device by which the packet is relayed in the communication network, analyzing the traffic information, and monitoring a flow of the packet with respect to the specific node.

### CROSS-REFERENCE TO RELATED APPLICATIONS

This application is a U.S. continuation application filed under 35 USC 111(a) claiming benefit under 35 USC 120 and 365(c) of PCT application JP07/055,231, filed Mar. 15, 2007. The foregoing application is hereby incorporated herein by reference.

### FIELD

The embodiments discussed herein generally relate to information processing apparatuses. In particular, the embodiments relate to an apparatus for determining the position of a specific node when performing a communication in a network using data packets.

### BACKGROUND

In a known technology for determining a route from a source node to a destination node in an ad-hoc network, the source node generates a data packet having fields for a source address, a destination address, and an indication that the source node requests information of route from the source node to the destination node.

Patent Document 1: Japanese Laid-Open Patent Application No. 2005-65267

Patent Document 2: U.S. Patent No. 2005/0036486 A1

Non-Patent Document 1: Routing and Switching Handbook (ISBN4-7980-0448-0), Shuwa System Co., Ltd.

Non-Patent Document 2: Cisco Catalyst LAN Switch Textbook, Revised, Aug. 1, 2004, Impress

### SUMMARY

One embodiment of the present disclosure is an information processing apparatus for performing a communication in a communication network using packets, the communication network including a relaying device having a function of acquiring traffic information of a packet that the relaying device relays. The information processing apparatus includes a transmission unit configured to transmit a packet to a specific node as a communication target; and a node position determining unit configured to determine a position of the specific node by acquiring the traffic information from the relaying device by which the packet is relayed in the communication network, analyzing the traffic information, and monitoring a flow of the packet with respect to the specific node.

Another embodiment provides an information processing apparatus including a request packet transmission unit configured to transmit a predetermined request packet to a specific node as a communication target in a communication network; and a position acquisition unit configured to determine a position of the specific node by acquiring information for a flow of a return packet returned by the specific node upon reception of the predetermined request packet. The return packet is transferred by a relaying device by which the packet is relayed in the communication network in a broadcast manner.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 depicts a diagram of a network in a building illustrating a problem to be solved by an embodiment;

FIG. 2A depicts a diagram of a network illustrating a conventional node position determining method;

FIG. 2B depicts a flowchart of the conventional node position determining method;

FIG. 3A depicts a diagram of a network illustrating a node position determining method according to an embodiment;

FIG. 3B depicts a flowchart of the node position determining method;

FIG. 4A depicts a diagram of a network illustrating a node position determining method according to an embodiment;

FIG. 4B depicts a flowchart of the node position determining method;

FIG. 5 depicts a chart illustrating differences between an embodiment and the related art;

FIG. 6 depicts a diagram illustrating a principle of operation of a node position search apparatus according to an embodiment;

FIG. 7 depicts a configuration of a network according to an embodiment;

FIG. 8 depicts a configuration of a network according to Example 1;

FIG. 9 depicts a flowchart of an operation of a node position search apparatus according to Example 1;

FIG. 10 depicts a configuration of a network according to Example 2;

FIG. 11 depicts a flowchart of an operation of a node position search apparatus according to Example 2;

FIG. 12 depicts a configuration of a network according to Example 3;

FIG. 13 depicts a flowchart of an operation of a node position search apparatus according to Example 3;

FIG. 14 depicts a configuration of a network according to Example 4;

FIG. 15 depicts a flowchart of an operation of a node position search apparatus according to Example 4;

FIG. 16 depicts detailed values for Example 1;

FIG. 17 depicts detailed values for Example 2;

FIG. 18 depicts detailed values for Example 4; and

FIG. 19 depicts a block diagram of a computer system for realizing the various embodiments.

### DESCRIPTION OF EMBODIMENTS

In the following description, the term “node” generally refers to a device to which an address is allocated, such as a relaying device, a repeater, a switch, a router, and a terminal.

As a result of the spread of the Ethernet computer-networking technologies for LANs (local area networks), the size of networks (or subnets) that can communicate at the layer 2 (“L2”) level is increasing. The fact that a specific node exists within a particular subnet may be known by sending a “ping” ICMP echo request or by the Address Resolution Protocol (ARP), but sometimes it is difficult to know the position of the specific node in the subnet (i.e., where it is connected).

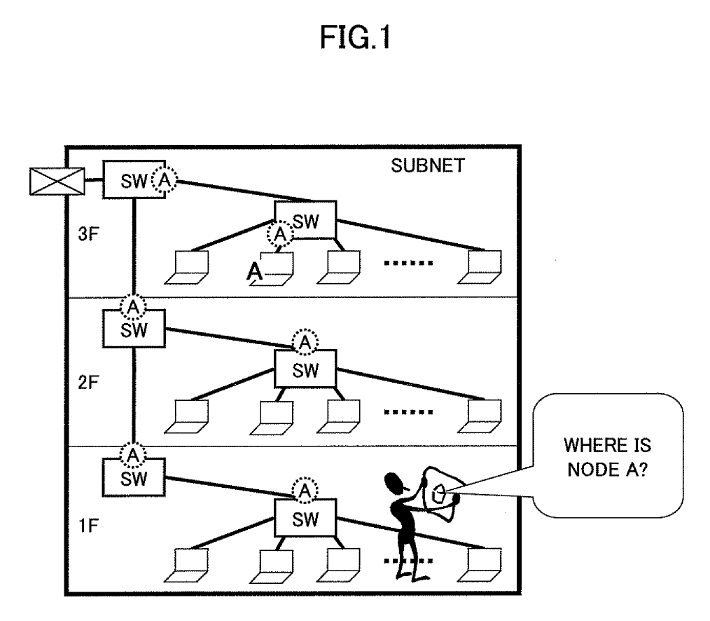

For example, when a network is set up in a three-storied (1F-3F) building as depicted in FIG. 1, a user may want to know the position of a specific node A. In a large subnet, redundant IP addresses can be easily detected by the ARP, for example. However, it is extremely difficult to find out the position of a specific node with a redundant IP address.

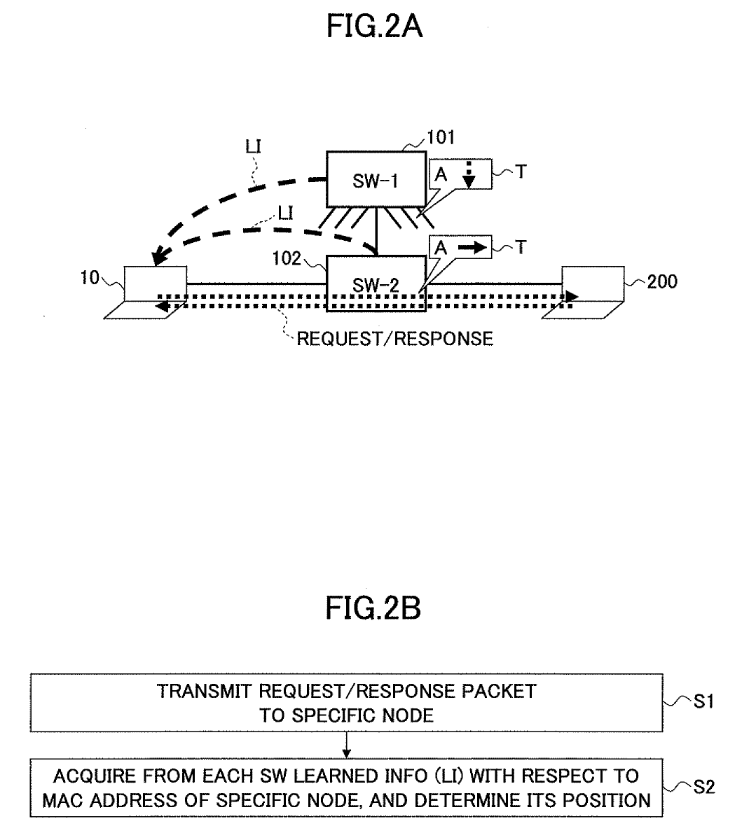

In a method for identifying the position of a specific node, a technology determines to which interface of each relaying switch the specific node is connected (see Patent Documents 1 and 2, for example). In this technology, the physical address (Media Access Control (MAC) address) of the specific node is learned by each switch, and the position of the specific node is identified by acquiring a learned direction, as described in FIGS. 2A and 2B.

Referring to FIGS. 2A and 2B, in a specific procedure of this method, a predetermined request/response type packet is transmitted from a search unit to a specific node (step S1). Each of switches SW-1(101) and SW-2(102), when transmitting the packet, obtains from a learning table (T) information (“learned information”: LI) about the direction from which the packet has arrived. The learned information may include the number (such as the port number) of the interface via which the packet has arrived, as a learned direction of the MAC address of the specific node that is set as a destination address of the packet. The search unit 10 then acquires the learned direction (LI) of the MAC address of the specific node 200 from each switch (step S2). The information of the learned direction acquired from each switch is then analyzed to identify the position of the specific node 200.

In the example depicted in FIG. 2A, when a packet is returned from the specific node 200 (MAC address: A) to the search unit 10, the return packet is transferred via the switches SW-2(102) and SW-1(101) in order. In this case, the return packet arrives at SW-2(102) from the specific node 200; namely, the specific node 200 is located to the right in FIG. 2A. Thus, the right direction is acquired from the learning table (T) of SW-2(102) as a learned direction of the return packet with respect to the originating address A. Similarly, in SW-1(101), the direction of arrival of the return packet is in the direction of SW-1(101); namely, downward in FIG. 2A. Thus, the downward direction is also acquired from SW-1(101) as a learned direction for the address A.

By thus separately acquiring the information (LI) about the learned directions of the address A of the specific node 200 from each switch, the search unit 10 can track the learned directions of the individual switches, thus obtaining the position of the specific node 200. Specifically, because the search unit 10 can recognize the fact that it has obtained the return packet from the specific node 200 with the address A through SW-1(101), the search unit 10 can acquire the information (LI) of the learned direction of the address A from SW-1(101).

Thus, the search unit 10 recognizes that the return packet that has arrived at SW-1(101) from the address A arrived via SW-2(102) located in the lower direction. The search unit 10 can therefore acquire the information (LI) about the learned direction of the address A from SW-2(102). As a result, it can be known that the return packet that has arrived at SW-2(102) from the address A arrived from the right direction. By thus successively acquiring the learned directions of the address A of the specific node 200 from each switch on the path, the position of the specific node 200 with the address A can eventually be obtained.

The details of the operation of the aforementioned switches are discussed on pages 39 to 41 and pages 57 to 60 of Non-Patent Document 1, for example.

In order to utilize the above method, the following conditions must be satisfied concerning the switches connected to the specific node as a search target and the network system configuration:

Applied condition 1: Information of a learned direction can be acquired by a search unit from each switch.

Applied condition 2: Information of a learned direction can be acquired from a switch located between the search unit and the specific node.

The above method cannot be used if, as in the following example, the communication network is configured or set such that information of a learned direction cannot be obtained from each switch in the system, thus failing to satisfy the above applied condition 1. Most of the so-called “intelligent switches” of recent years are adapted for the acquisition of such information of a learned direction. However, in the case of a so-called management VLAN (virtual LAN) where a LAN for user traffic and a management VLAN for acquiring device information are separately provided, for example, information of a learned direction of a specific node may not be acquired, thus failing to satisfy the applied condition 1.

Examples of such switches where learned information in a switch that belongs to a certain VLAN cannot, at least simply, be acquired from the management VLAN, are Catalyst 2950, Catalyst 2970, Catalyst 3550, Catalyst 3750, and Catalyst 6503 from Cisco Systems, Inc. The details of these switches are described on pages 65 to 74 of Non-Patent Document 2. Even when the communication network is configured such that, as in the following example, learned information can be acquired from the switches in the system, the above applied condition 2 may not be satisfied if a switch on a path between the search unit and a specific node happened to be set so that learned information cannot be acquired from the switch, thus preventing the application of the above method.

Specifically, there are many environments in which core (upstream) switches alone comprise intelligent switches while terminal (downstream) switches comprise non-intelligent switches. In such a case, learned information may not be obtained from the switch between the search unit and the specific node, thus failing to satisfy the applied condition 2.

When either the applied condition 1 or 2 is not satisfied and the above method cannot be utilized, identifying the position of a specific node requires great amounts of time and effort for collecting information from a device console of the search unit, collating information using a packet capture, and so on.

### Embodiments

Referring now to the drawings, wherein like reference numerals designate identical or corresponding parts throughout the several views, embodiments are described. First, the basic concepts of the embodiments are described.

In a first method according to an embodiment, on the assumption of a situation where the aforementioned applied condition 1 is not satisfied, the position of a specific node is identified from information other than learned information. When a packet is transmitted from a search unit to a specific node in a network, the outgoing packet is transferred by each switch in the network in the direction of an interface to which the specific node is connected (such as a corresponding port). Thus, if information of the flow of the packet can be extracted, the position of the specific node can be determined without necessarily using learned information.

Specifically, in the first method, a dummy packet that can be distinguished from other traffic is sent from the search unit to the specific node, and the flow of the dummy packet is extracted by acquiring traffic information from each switch as a search target in order to determine the position of the specific node.

Alternatively, in a second method, a situation is assumed in which the aforementioned applied condition 2 is not satisfied. In this method, the network is configured such that the MAC address of a specific node is learned by all of the switches. Thus, in the second method, the specific node outputs “a packet that behaves in a broadcast fashion”. The “packet that behaves in a broadcast fashion” refers to a situation in which a packet controls each switch that has received the packet to output the received packet in all directions, i.e., to all of the interfaces other than the interface at which the packet has arrived, as a so-called broadcast traffic.

It is generally difficult to cause a specific node in a network to output a packet that behaves in a broadcast fashion. However, the specific node can be controlled to output a packet that behaves in a broadcast fashion (i.e., a so-called unknown unicast packet) by using a MAC address that is not learned by the switches in the network. Such a behavior of an unknown unicast packet in a broadcast fashion, i.e., the flooding of the packet as a packet with an unknown communication path, is described on page 58 of Non-Patent Document 1, for example.

Based on this concept, in the second method, a dummy request packet is transmitted from the search unit to a specific node so that the specific node responds with a packet that behaves in a broadcast fashion. In response to the dummy request packet, the specific node outputs a packet that behaves in a broadcast fashion. Upon reception of the packet, each switch outputs the received packet in all directions as a broadcast traffic, i.e., to all interfaces other than the arriving interface, as described above.

As each switch that has received the packet successively outputs the packet as a broadcast traffic, all of the switches in the network (or a subnet) handles the packet. Thus, all of the switches acquire learned information of the packet that behaves in a broadcast fashion, or information of the traffic.

The search unit then acquires from each switch the learned information or traffic information that has been acquired about the packet that behaves in a broadcast fashion, namely, the response packet. The search unit then analyzes the learned information or the traffic information from each switch, and determines a flow of the packet. Thus, the search unit can extract the source of the response packet and determine the position of the specific node as the source, without requiring either the applied condition 1 or 2.

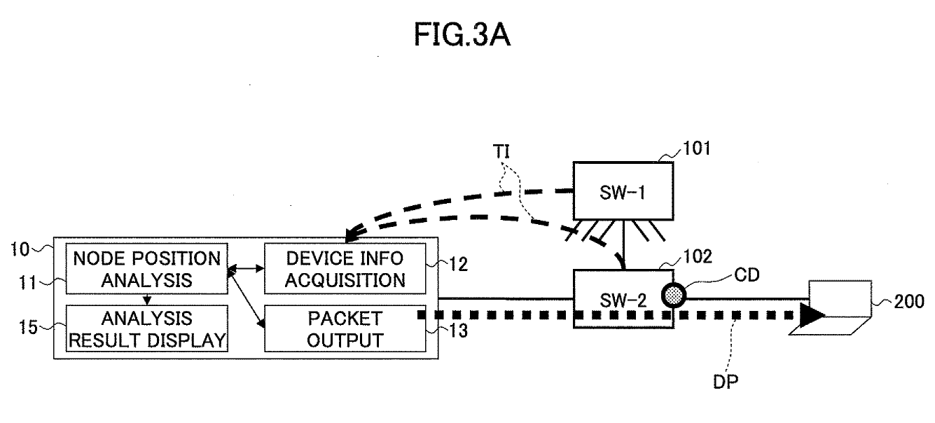

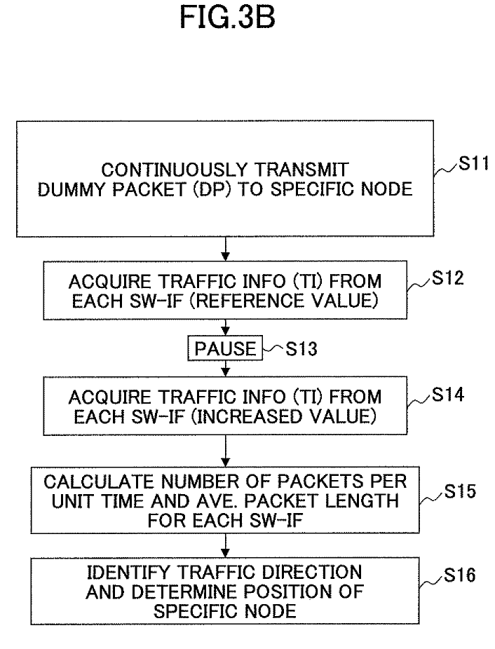

FIG. 3A depicts a node position search apparatus 10 according to an embodiment (for the first method). The node position search apparatus 10 includes a node position analysis function unit 11 for analyzing a node position; a packet output function unit 13 for generating and outputting a packet; a device information acquisition function unit 12 for acquiring necessary information from a switch; and an analysis result display function unit 15 for displaying an analysis result to a user.

Referring to FIGS. 3A and 3B, the packet output function unit 13 transmits a dummy packet (DP) to a specific node 200 in a pattern distinguishable from other traffic (step S11). The device information acquisition function unit 12 acquires traffic information (TI) from switches SW-1(101) and SW-2(102) as search targets (steps S12 and S14). The node position analysis function unit 11 extracts a flow of the dummy packet (DP) from the traffic information (TI), thereby determining a connected direction (CD) in which the specific node 200 is connected (steps S15 and S16). The connected direction of the specific node 200 thus identified is displayed by the analysis result display function unit 15. Thus, the need for the applied condition 1 is eliminated.

The packet output function unit 13 may employ a short or long packet as the dummy packet (DP) that is configured such that the specific node 200 does not respond, as will be described later (step S11). In this case, the position of the specific node 200 is determined from information of the transmission traffic of each interface of the search target switches SW-1(101) and SW-2(102) (such as the number of packets per unit time, and an average packet length) (step S15).

Alternatively, the packet output function unit 13 may output as the dummy packet a short or long packet configured such that the specific node 200 responds, as will be described later. In this case, the position of the specific node 200 is determined from information of a response reception traffic of each interface of the search target switches SW-1(101) and SW-2(102), or information of the relationship between a request transmission traffic and a response reception traffic.

The traffic information acquired by the device information acquisition function unit 12 may include the number of packets per unit time in a transmission or reception interface (IF), or a calculated average packet length (step S15). Thus, a traffic due to the dummy packet can be effectively distinguished from other traffic.

The traffic information that is acquired may be provided by an INTERFACE-MIB (management information base) giving the traffic volume (if InOctets/if OutOctets) and the number of packets (if InUcastPkts/if OutUcastPkts), or a RMON-MIB (remote network monitoring MIB). The INTERFACE-MIB and RMON-MIB may be implemented on general intelligent switches (capable of acquiring device information).

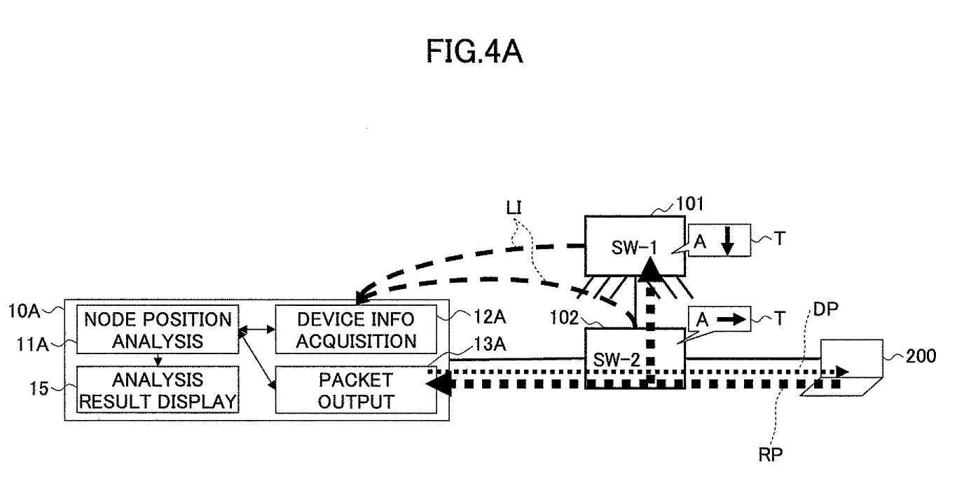

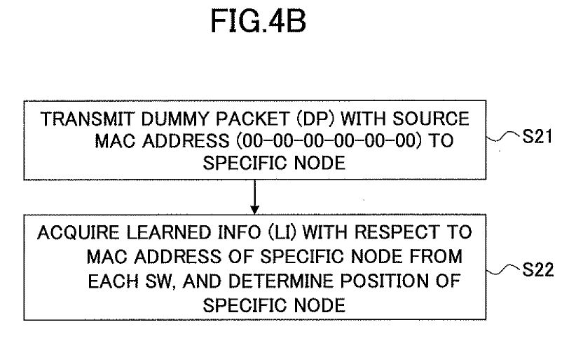

FIG. 4 depicts a node position search apparatus 10A according to an embodiment (for the second method). The node position search apparatus 10A includes a node position analysis function unit 11A for analyzing a node position; a packet output function unit 13A for generating/outputting a packet; a device information acquisition function unit 12A for acquiring necessary information from a switch; and an analysis result display function unit 15 for displaying an analysis result to a user.

The packet output function unit 13A transmits a dummy request packet (DP) such that a specific node 200 responds with a response packet (RP) that behaves in a broadcast fashion (step S21). The device information acquisition function unit 12A acquires learned information (LI) from search target switches SW-1(101) and SW-2(102). The node position analysis function unit 11A determines a direction in which the specific node 200 is connected, from the learned information (LI) (step S22). The determined connected direction of the specific node 200 is displayed by the analysis result display function unit 15.

In the dummy request packet (DP) delivered in step S21 by the packet output function unit 13A, an address that is not learned by the switches is set as the physical address of the source. Generally, a switch operating in the L2 protocol does not learn an all-zero physical address (i.e., “00:00:00:00:00:00”). Thus, when the request packet (DP) is transmitted to the specific node 200 by setting such a physical address as the physical address of the source of transmission, the destination (i.e., the physical address with all zeroes) of the response packet (RP) sent back by the specific node 200 is not learned by any of the relaying switches SW-1(101) and SW-2(102). As a result, the response packet (RP) is delivered from each switch in a broadcast fashion (i.e., as an unknown unicast packet).

Examples of the switch that does not learn the MAC address with all zeroes and that transfers the received packet in a broadcast fashion include Catalyst 2950, Catalyst 2970, and Catalyst 3750 from Cisco Systems, Inc. The details of such switches are described on pages 65 to 74 of Non-Patent Document 2, for example.

According to another embodiment, a node position search apparatus for implementing the second method includes a node position analysis function unit 11A for analyzing a node position; a packet output function unit 13A for generating/outputting a packet; a device information acquisition function unit 12A for acquiring necessary information from a switch; and an analysis result display function unit 15 for displaying an analysis result to a user. While the packet output function unit 13A transmits a dummy request packet such that a specific node responds with a packet that behaves in a broadcast fashion, the device information acquisition function unit 12A acquires traffic information from the search target switches SW-1(101) and SW-2(102). The node position analysis function unit 11A then extracts information for a flow of the dummy request traffic or a response traffic from the traffic information, thereby determining a connected direction of the specific node 200. The determined connected direction of the specific node 200 is displayed by the analysis result display function unit 15.

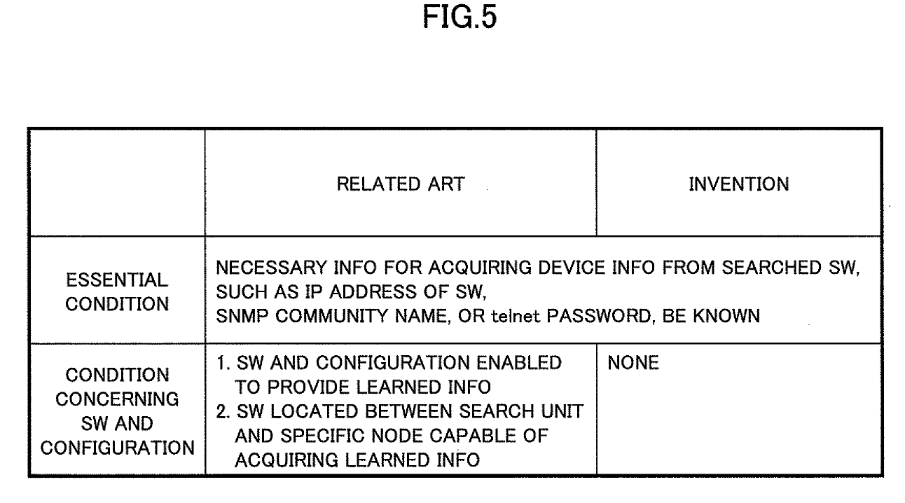

With reference to FIG. 5, differences between the related art and an embodiment in terms of their respective essential conditions are described. As depicted in FIG. 5, in both the related art and the present embodiment, an essential condition requires that, separately from the L2 level communication for ordinary packet exchange, necessary information for acquiring device information from a search target switch be known via an IP communication by the Simple Network Management Protocol (SNMP), for example. In other words, it is required that information such as the IP address of the switch, an SNMP community name, and a telnet password be known.

However, the embodiment requires neither the condition that the switch or the network be configured such that learned information can be acquired (applied condition 1), nor the condition that learned information be capable of being acquired from a switch located between a search unit and a specific node (applied condition 2). Both of these conditions are required by the related art.

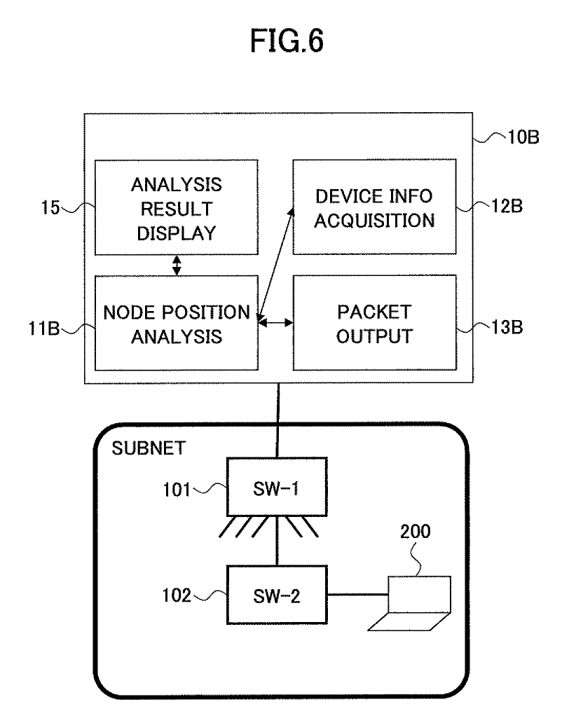

FIG. 6 depicts a block diagram of a node position search apparatus 10B according to an embodiment. The node position search apparatus 10B includes a node position analysis function unit 11B for analyzing a position of the specific node 200; a packet output function unit 13B for generating and outputting a packet; a device information acquisition function unit 12B for acquiring necessary information from devices 101 and 102; and an analysis result display function unit 15 for displaying an analysis result to a user.

Thus, according to the foregoing embodiments, the condition concerning the switch or network being configured such that learned information can be acquired is not required. Further, information from a switch other than the switch between the search unit and the specific node can be utilized.

Thus, even when the applied conditions 1 and 2, which are essential according to the related art, are not satisfied, the position of the specific node can be identified, whereby the necessary time and effort can be effectively reduced.

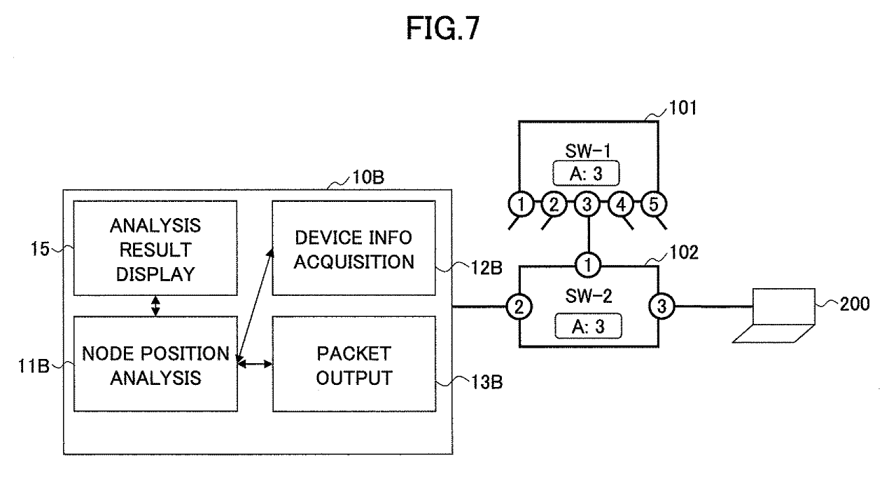

FIG. 7 depicts a network configuration that may be used in any of the foregoing embodiments. The network includes the node position search apparatus 10B, the specific node 200, and the SW-1(101) and SW-2(102) connected as depicted. The switches SW-1(101) and SW-2(102) are search target switches. Each of the switches SW-1(101) and SW-2(102) is an intelligent switch, so that the node position search apparatus 10B can acquire MIB (management information base) information (i.e., learned information or traffic information) from each of the switches SW-1(101) and SW-2(102) by SNMP communication. The learned information or traffic information may be acquired from the SW-1(101) and SW-2(102) in other ways than by using SNMP, such as by using telnet.

### Example 1

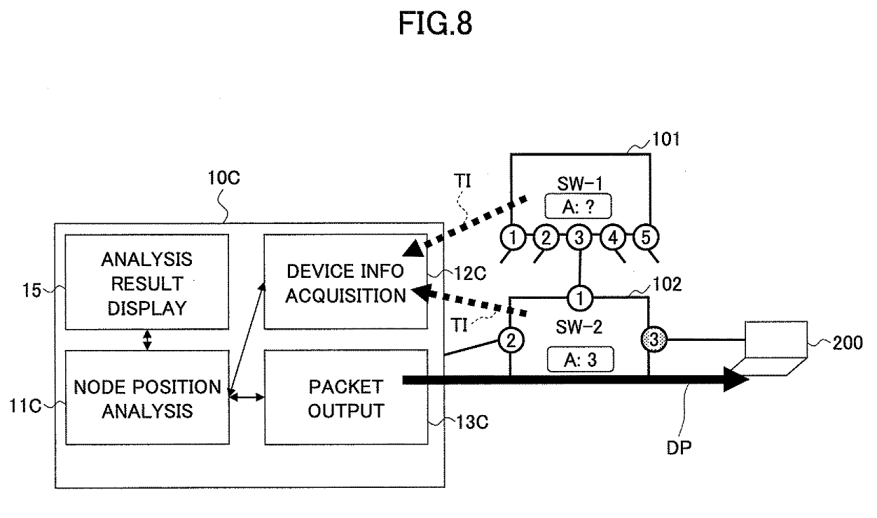

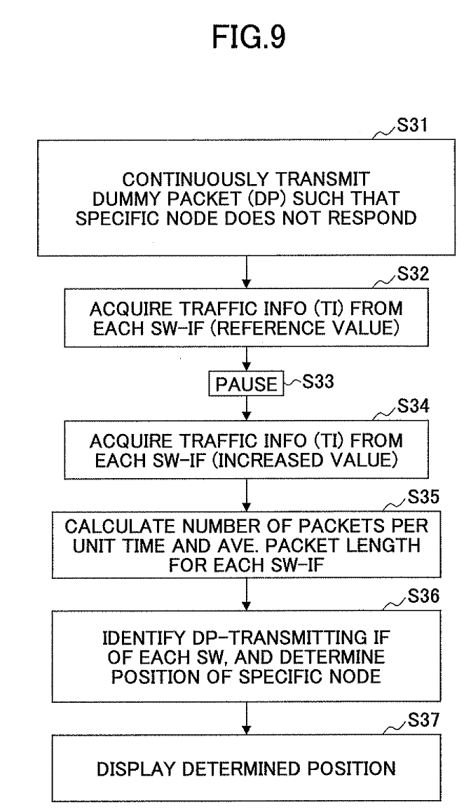

A node position search apparatus 10C according to Example 1 (for the first method) is described with reference to FIGS. 8 and 9. The node position search apparatus 10C includes a packet output function unit 13C that keeps outputting a dummy packet (DP) to the specific node 200 such that the specific node 200 does not respond (step S31). The device information acquisition function unit 12C then acquires traffic information (TI) about transmission traffic volume and the number of transmitted packets twice from an interface of each of the switches SW-1(101) and SW-2(102) (steps S32 and S34). Based on differences between the values obtained at those steps, the node position analysis function unit 11C calculates the number of packets transmitted per unit time (i.e., transmission speed) and an average transmission packet length (step S35).

Based on the obtained information, the node position analysis function unit 11C determines the position of the specific node 200 (step S36), and the result is displayed by the analysis result display function unit 15 on a screen (not shown) of the node position search apparatus 10C (step S37).

In FIGS. 7, 8, 10, 12, and 14, the numbers within circles in the switches SW-1(101) and SW-2(102) may designate the port number of each interface. For example, in FIG. 8, SW-1(101) is connected to SW-2(102) via an interface No. 3. SW-2(102) is connected to SW-1(101) via an interface No. 1 and to the node position search apparatus 10C via an interface No. 2. In each of the SW-1(101) and SW-2(102), the information in a round-cornered rectangle indicates the number of a learned interface. Specifically, “A” indicates the originating address of a received packet, and the number in the circle (such as “2”) indicates the number of the interface at which the received packet has arrived.

For example, referring to FIG. 8, in SW-1(101), no learned information of the MAC address “A” is obtained, while in SW-2(102), the interface number “3” is obtained as a learned direction for the MAC address “A”. In this case, a packet from the specific node 200 with the MAC address “A” has been received by SW-2(102) via the interface No. 3, and that the learned information obtained is “A: 3”.

FIG. 9 depicts a flowchart of the above operation of the node position search apparatus 10C. In step S31, the node position search apparatus 10C keeps transmitting a dummy short packet (DP) (such as of 64 bytes) to the specific node 200 at a constant speed (such as 1000 pps). The dummy packet (DP) in this case is not limited to the short packet described above, but may have any desired structure, such as a long packet that enables the packet to be readily distinguished from other user traffic or the like.

In step S32, the node position search apparatus 10C acquires from SW-1(101) and SW-2(102) traffic information (TI) including the transmission traffic volume (such as if OutOctets MIB) and a transmission packet counter value (such as if OutUcastPkts MIB) by SNMP. The acquired values, which are accumulated value information in each switch since the startup of the system, are used as reference values.

Thereafter, in step S33, the node position search apparatus 10C waits for a certain pause time (such as 5 seconds), and then in step S34 again acquires from SW-1(101) and SW-2(102) the traffic information (TI) including the transmission traffic volume (such as if OutOctets MIB) and the transmission packet counter value (such as if OutUcastPkts MIB) by SNMP. The thus acquired data is utilized as increased values indicating the increases over the reference values that are produced during the pause time.

According to Example 1, the transmission counter of the interface No. 3 of SW-2(102) should show an increased value compared with the value that has been obtained in step S32, due to the dummy packet continuously transmitted in step S31. In step S35, the node position search apparatus 10C calculates the number of packets transmitted per unit time and an average packet length from the difference between the values obtained in steps S32 and S34.

By thus dividing the difference value in the transmission packet counter value by the aforementioned certain pause time, the number of packets transmitted per unit time, i.e., the transmission speed (pps), can be obtained. By dividing the difference value in the transmission traffic volume by the certain pause time and further by the transmission speed (pps), the average transmission packet length can be obtained.

In step S36, based on the values calculated in step S35, the interface number used for transmission of the dummy packet in each of SW-1(101) and SW-2(102) is identified. The identifying method may involve determining whether the speed at which the dummy packet is outputted in step S31 and the packet length is each within a threshold range (such as 5%) of a calculated value that is set in advance.

Specifically, in step S31, the dummy packet having a certain packet length is outputted at a certain speed. The dummy packet is transferred via SW-1(101) and SW-2(102) to the specific node 200. Therefore, the average packet length and the number of packets transmitted per unit time from each of the switches should exhibit values close to the packet length and the output speed upon output of the dummy packet.

Thus, an interface is extracted that has values close to the packet length and the output speed at the time of output of the dummy packet by referring to the average packet length and the per-unit-time number of transmitted packets of each interface of each switch. Then, the number of the extracted interface should indicate the destination of the dummy packet, i.e., the direction of the position of the specific node 200. In this way, the direction of the specific node 200 can be obtained.

In accordance with the present example, as depicted in FIG. 8, the switch on a communication path between the node position search apparatus 10C and the specific node 200 is SW-2(102); SW-1(101) is assumed not to be included. In this case, no corresponding interface should be extracted from SW-1(101); instead, the interface No. 3 should be extracted from SW-2(102) as the relevant interface.

The communication path between the node position search apparatus 10C and the specific node 200 may be determined in advance by the following operation. Namely, the specific node 200 transmits a user traffic packet to the node position search apparatus 10C. Upon reception of this packet as an unknown unicast packet via the interface No. 3, SW-2(102) performs a flooding, so that the packet eventually arrives at the node position search apparatus 10C from SW-2(102). At this time, SW-2(102) has learned No. 3 as the number of the arriving interface concerning the MAC address A as the source of transmission of the unknown unicast packet, as described above.

As a result, when a packet arrives at SW-2(102) addressed to the specific node 200 (i.e., MAC address A) from the node position search apparatus 10C, SW-2(102) searches for learned information using the MAC address (A) as a key, eventually obtaining the aforementioned learned information, “A: 3”. Thus, SW-2(102) outputs the received packet to the interface No. 3. As a result, the packet arrives at the specific node 200 connected to the relevant interface. The transfer path of the packet in this case is the communication path between the node position search apparatus 10C and the specific node 200.

Referring back to FIG. 9, in step S37, the numbers of the transmission interfaces extracted from SW-1(101) and SW-2(102) are displayed on a screen or the like as an identified result concerning the direction of the node position. Specifically, in the example of FIG. 8, the interface No. 3 of SW-2(102) is displayed on the screen of the node position search apparatus as the direction of the specific node 200.

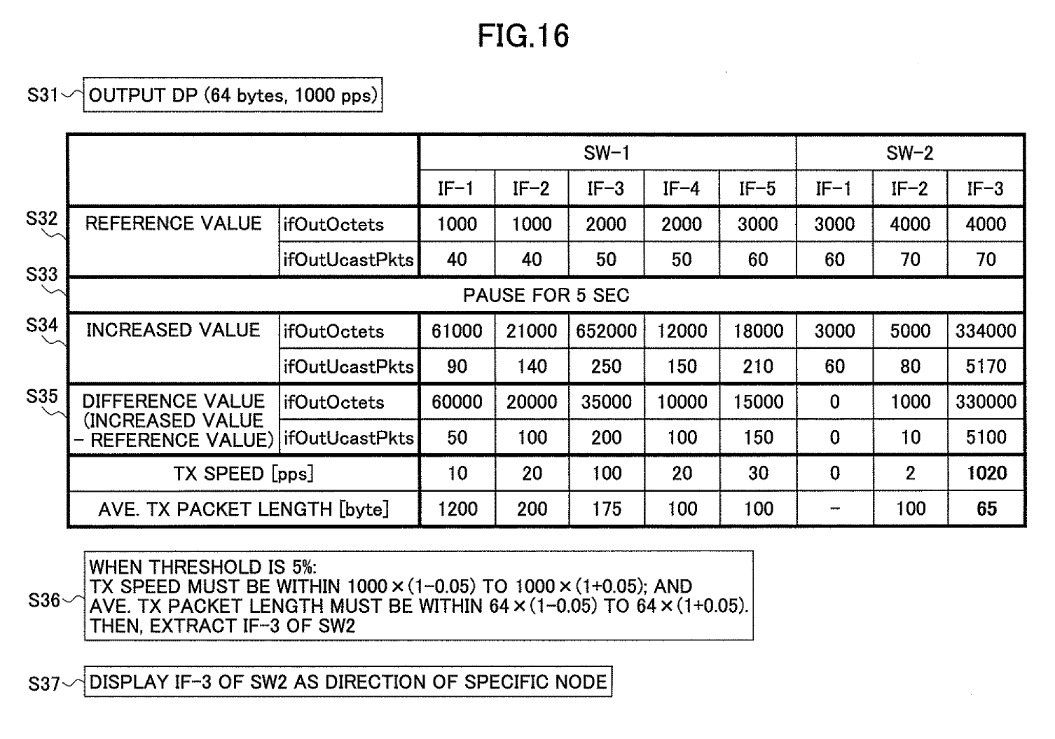

FIG. 16 depicts exemplary values in the case of Example 1. When a dummy packet with a packet length of 64 bytes is outputted at 1000 pps in step S31, the traffic information of each switch obtained in the initial stage in step S32 indicates, for the interfaces Nos. 1 through 5 of the SW-1(101), the transmission traffic volume (accumulated total) of 1000, 1000, 2000, 2000, and 3000, respectively; and the number of transmitted packets (accumulated total) of 40, 40, 50, 50, and 60, respectively. Similarly, for the interfaces Nos. 1 through 3 of SW-2(102), the transmission traffic volume (accumulated total) is 3000, 4000, and 4000, respectively; and the number of transmitted packets (accumulated total) is 60, 70, and 70, respectively.

Thereafter, the traffic information of each switch that is obtained in the next step S34 after the pause time of five seconds in step S33 is, for the interfaces Nos. 1 through 5 of SW-1(101), the transmission traffic volume (accumulated total) of 61000, 21000, 652000, 12000, and 18000, respectively; and the number of transmitted packets (accumulated total) of 90, 140, 250, 150, and 210, respectively. Similarly, for the interfaces Nos. 1 through 3 of SW-2(102), the transmission traffic volume (accumulated total) is 3000, 5000, and 334000, respectively; and the number of transmitted packets (accumulated total) is 60, 80, and 5170, respectively.

In step S35, differences between the values obtained in steps S32 and S34 are determined. The difference in the number of transmitted packets is then divided by the pause time (5 sec), obtaining a transmission speed (pps). Further, the difference value in the transmission traffic volume is divided by the pause time (5 sec), obtaining a per-unit-time transmission traffic volume. By dividing the per-unit-time transmission traffic volume by the transmission speed (pps), an average packet length can be obtained.

The transmission speed (pps) thus obtained of each switch on an interface basis is, as depicted in FIG. 16, 10, 20, 100, 20, and 30 (pps) for the interfaces Nos. 1 through 5, respectively, of SW-1(101); and 0, 2, and 1020 (pps) for the interfaces Nos. 1 through 3, respectively, of SW-2(102). Similarly, the average packet length is 1200, 200, 175, 100, and 100 bytes for the interfaces Nos. 1 through 5, respectively, of SW-1(101); and unknown, 100, and 65 bytes for the interfaces Nos. 1-3, respectively, of SW-2(102).

The packet length of the dummy packet outputted in step S31 is 64 bytes, and the transmission speed is 1000 pps. Thus, when the aforementioned threshold is 5%, the allowable range of the packet length is 64×0.95 to 1.05=60.8 to 67.2 bytes, and the allowable range of the transmission speed is 1000×0.95 to 1.05=950 to 1050 pps. These conditions are satisfied by the 65 bytes and 1020 pps of the interface No. 3 of SW-2(102) alone. As a result, the interface No. 3 of SW-2(102) is extracted (step S36).

In step S37, the interface No. 3 of SW-2(102) is displayed as the direction indicating the position of the specific node 200.

### Example 2

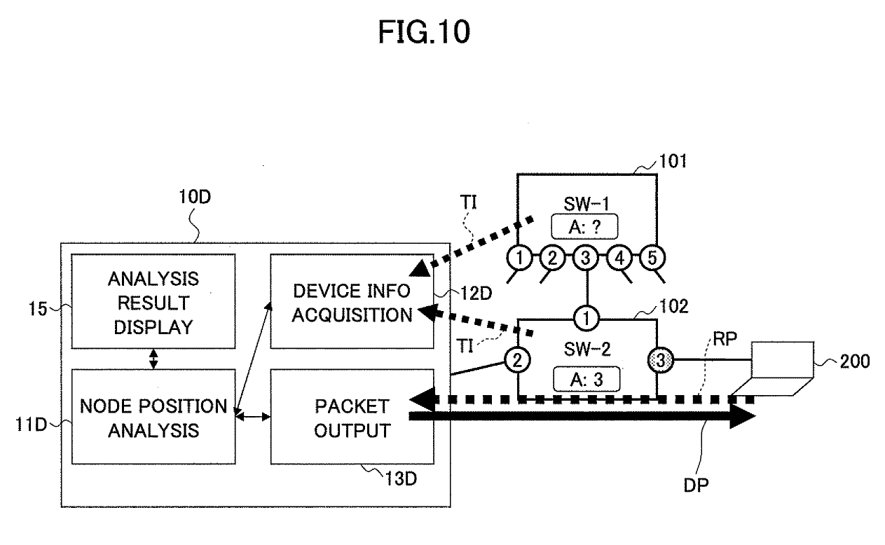

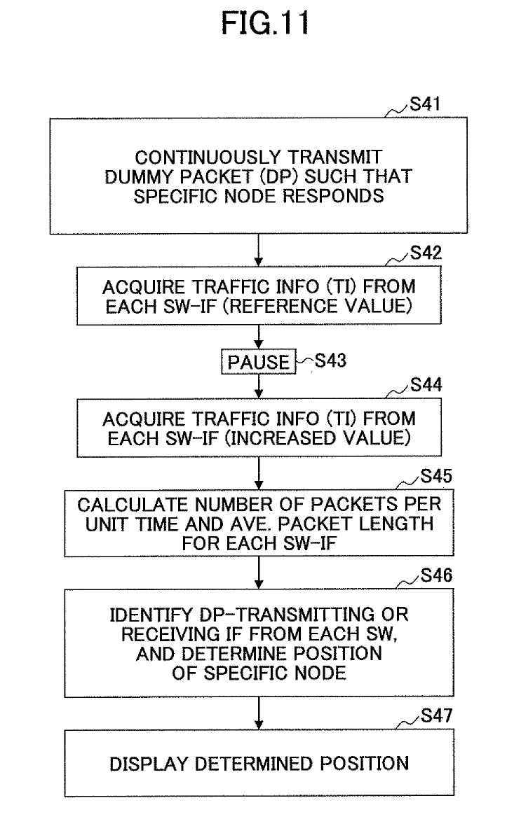

Hereafter, a node position search apparatus 10D according to Example 2 (for the first method) is described with reference to FIGS. 10 and 11. In the node position search apparatus 10D, a packet output function unit 13D keeps outputting a dummy packet (DP) to the specific node 200 such that the specific node 200 responds (step S41). A device information acquisition function unit 12D then acquires from each interface of each of the switches SW-1(101) and SW-2(102) traffic information (TI) about the transmission/reception traffic volume and the number of transmitted/received packets, each twice (steps S42 and S44). A node position analysis function unit 11D calculates a per-unit-time number of transmitted/received packets and an average transmitted/received packet length from the difference between the values obtained at the preceding steps (step S45). Based on the resultant information, the position of the specific node 200 is identified (step S46), and the result is displayed by an analysis result display function unit 15 (step S47).

The above operation is described in detail with reference to FIG. 11.

In step S41, the node position search apparatus 10D keeps transmitting a unicast ARP (Address Resolution Protocol) request packet (DP) of a long size (such as 1500 bytes) to the specific node 200 at a constant speed (such as 1000 pps). The specific node 200, each time it receives the ARP request packet (DP), returns an ARP response packet (RP) of a short size (64 bytes) to the node position search apparatus 10D. This is due to the fact that in the case of an ARP packet, the size of the response packet is fixed to 64 bytes regardless of the size of the request packet (DP). By taking advantage of this size difference, the direction of the request packet (DP) and that of the response packet (RP) can be determined from the traffic information (TI) obtained from each switch.

The node position search apparatus 10D may transmit a request/response type packet other than the ARP packet as described above.

In step S42, a transmission/reception traffic volume (such as if OutOctets MIB and if InOctets MIB) and a transmitted/received packet counter value (such as if OutUcastPkts MIB and if InUcastPkts MIB) are acquired from SW-1(101) and SW-2(102) by SNMP. Because these acquired values indicate information of the accumulated values since the startup of the system, they are utilized as reference values.

In step S43, a certain pause time (such as 5 sec) is allowed to pass.

In step S44, a transmission/reception traffic volume (such as if OutOctets MIB and if InOctets MIB) and a transmitted/received packet counter value (such as if OutUcastPkts MIB and if InUcastPkts MIB) are again acquired from SW-1(101) and SW-2(102), using SNMP. The obtained data is used as increased value data.

In accordance with the present example, the transmission/reception counter of the interface No. 3 of SW-2(102) should indicate an increase compared to the data acquired in step S42 due to the transmission/reception of the dummy request/response packet in step S41.

In step S45, a per-unit-time transmitted/received packet number, i.e., a transmission/reception speed, and an average transmitted/received packet length are calculated from the information obtained in steps S42 and S44.

In step S46, an interface of SW-1(101) and SW-2(102) that received the response packet or transmitted the dummy request packet is extracted from the values calculated in step S45. The extraction method may involve, as in the case of the foregoing Example 1, determining whether each calculated value is within a range of threshold (such as 5%) of the output speed of the dummy request packet outputted in step S41 or the outgoing packet length.

In accordance with Example 2, as depicted in FIG. 10, no such interface is extracted from SW-1(101), which is not included in the communication path of the dummy request packet or the response packet. Instead, the interface No. 3 of SW-2(102) on the communication path is extracted as the request packet transmission interface and the response packet reception interface.

Thus, in accordance with Example 2, a request/response type packet is transmitted in step S41, so that both a request packet transmission interface and a response packet reception interface on the communication path can be extracted. Thus, the position of the specific node 200 can be determined more accurately than by Example 1.

In step S47, the directions of the interfaces extracted from SW-1(101) and SW-2(102) are displayed as a result of determination of the position of the specific node 200.

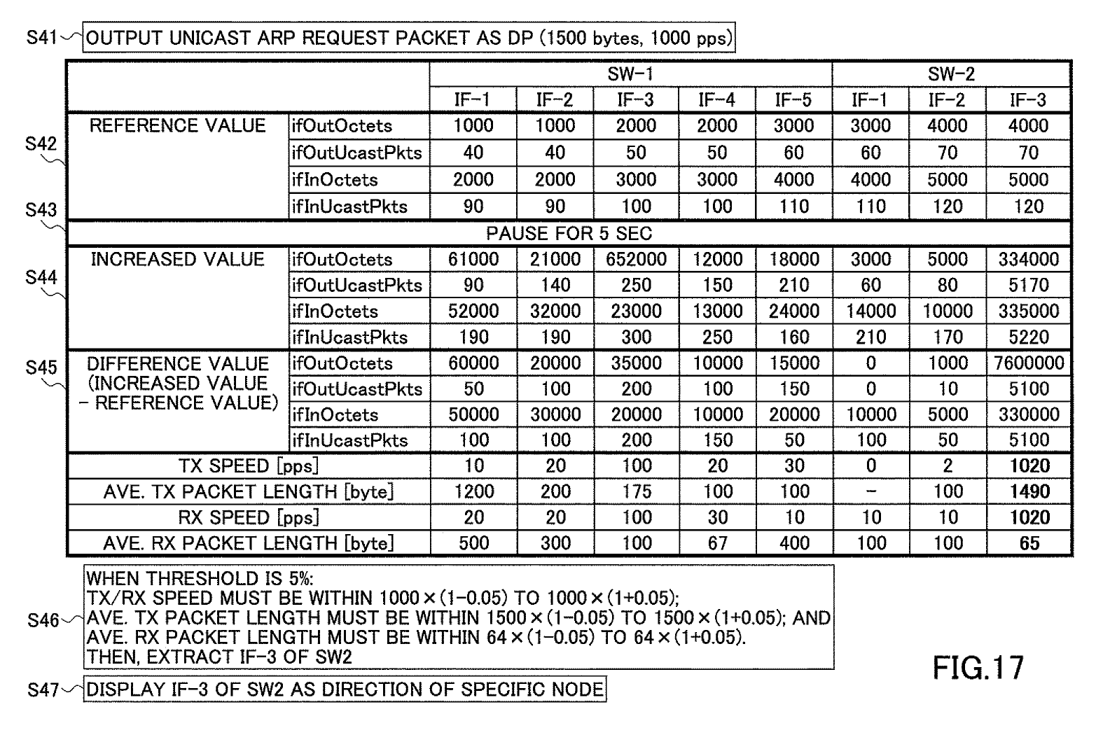

FIG. 17 depicts exemplary values in the case of Example 2. When a dummy packet with a packet length of 1500 bytes is transmitted at 1000 pps in step S41, the traffic information of each switch obtained in the initial stage of step S42 indicates the transmission traffic volume (accumulated total) of 1000, 1000, 2000, 2000, and 3000, and the number of transmitted packets (accumulated total) of 40, 40, 50, 50, and 60 for the interfaces Nos. 1 through 5, respectively, of SW-1(101). Similarly, for the interfaces Nos. 1 through 3 of the SW-2(102), the transmission traffic volume (accumulated total) is 3000, 4000, and 4000, respectively, and the number of transmitted packets (accumulated total) is 60, 70, and 70, respectively.

For the interfaces Nos. 1 through 5 of SW-1(101), the reception traffic volume (accumulated total) is 2000, 2000, 3000, 3000, and 4000, respectively; and the number of transmitted packets (accumulated total) is 90, 90, 100, 100, and 110, respectively. Similarly, for the interfaces Nos. 1 through 3 of SW-2(102), the reception traffic volume (accumulated total) is 4000, 5000, and 5000, respectively; and the number of transmitted packets (accumulated total) is 110, 120, and 120, respectively.

After the pause time of 5 seconds in step S43, the traffic information of each switch obtained in the next stage in step S44 indicates as follows. Specifically, for the interfaces Nos. 1 through 5 of SW-1(101), the transmission traffic volume (accumulated total) is 61000, 21000, 652000, 12000, and 18000, respectively; and the number of transmitted packets (accumulated total) is 90, 140, 250, 150, and 210, respectively. Similarly, for the interfaces Nos. 1 through 3 of SW-2(102), the transmission traffic volume (accumulated total) is 3000, 5000, and 334000, respectively; and the number of transmitted packets (accumulated total) is 60, 80, and 5170, respectively.

For the interfaces Nos. 1 through 5 of SW-1(101), the reception traffic volume (accumulated total) is 52000, 32000, 23000, 13000, and 24000, respectively; and the received packet number (accumulated total) is 190, 190, 300, 250, and 160, respectively. Similarly, for the interfaces Nos. 1 through 3 of SW-2(102), the reception traffic volume (accumulated total) is 14000, 10000, and 335000, respectively; and the received packet number (accumulated total) is 210, 170, and 5220, respectively.

In step S45, the differences in the values between steps S42 and S44 are determined. The difference in the number of transmitted packets is divided by the aforementioned pause time (5 seconds), obtaining a transmission speed (pps). By dividing the difference value in the transmission traffic volume by the pause time (5 seconds), a per-unit-time transmission traffic volume is obtained. By further dividing the per-unit-time transmission traffic volume by the transmission speed (pps), an average transmission packet length is obtained.

The transmission speed (pps) for each switch thus obtained is, as depicted in FIG. 17, 10, 20, 100, 20, and 30 (pps) for the interfaces Nos. 1 through 5, respectively, of SW-1(101); and 0, 2, and 1020 (pps) for the interfaces Nos. 1 through 3, respectively, of SW-2(102). Similarly, the average transmission packet length is 1200, 200, 175, 100, and 100 (bytes) for the interfaces Nos. 1 through 5, respectively, of SW-1(101); and unknown, 100, and 1490 (bytes) for the interfaces Nos. 1 through 3, respectively, of SW-2(102).

Similarly, by dividing the difference in the received packet number by the pause time (5 seconds), a reception speed (pps) is obtained. By dividing the difference value in the reception traffic volume by the pause time (5 seconds), a per-unit-time reception traffic volume is obtained. By further dividing the per-unit-time reception traffic volume by the reception speed (pps), an average received packet length is obtained.

The reception speed is 20, 20, 100, 30, and 10 (pps) for the interfaces Nos. 1 through 5, respectively, of SW-1(101); and 10, 10, and 1020 (pps) for the interfaces Nos. 1 through 3, respectively, of SW-2(102). Similarly, the average received packet length is 500, 300, 100, 67, and 400 (bytes) for the interfaces Nos. 1 through 5, respectively, of SW-1(101); and 100, 100, and 65 (bytes) for the interface Nos. 1 through 3 of SW-2(102). Because the packet length of the dummy packet outputted in step S41 is 1500 bytes, and the transmission speed is 1000 pps, the allowable range of the packet length when the aforementioned threshold is 5% is 1500×0.95 to 1.05=1425 to 1575 bytes, while the allowable range of the transmission speed is 1000×0.95 to 1.05=950 to 1050 pps.

The size of the response packet is fixed to 64 bytes, as mentioned above. The response speed should be the same as the output speed, at 1000 pps. Thus, when the aforementioned threshold is 5%, the allowable range of the received packet length is 64×0.95 to 1.05=60.8 to 67.2 bytes, while the allowable range of the reception speed is 1000×0.95 to 1.05=950 to 1050 pps. These conditions are only satisfied by the 1490 bytes and 1020 pps of the interface No. 3 of SW-2(102) for transmission, and the 65 bytes and 1020 pps of the interface No. 3 of SW-2(102) for reception. Thus, the interface No. 3 of SW-2(102) is extracted (step S46).

In step S47, the interface No. 3 of SW-2(102) is displayed as the direction indicating the specific node 200.

### Example 3

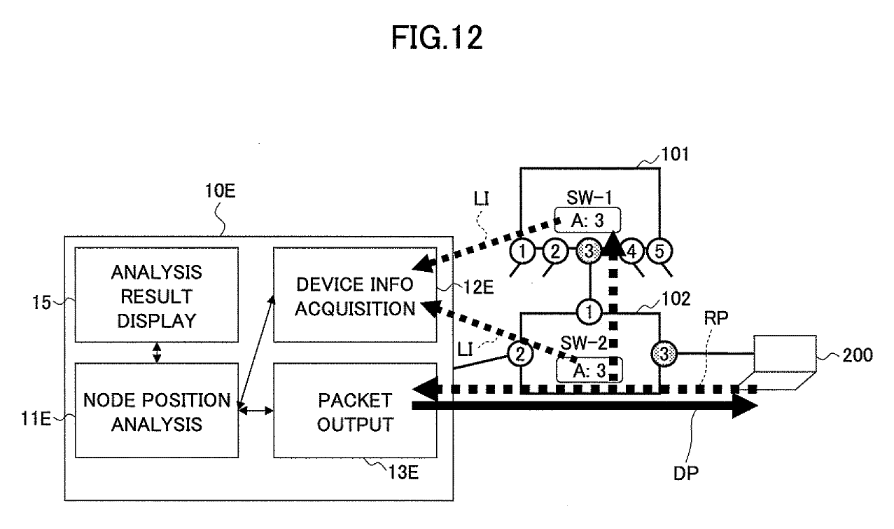

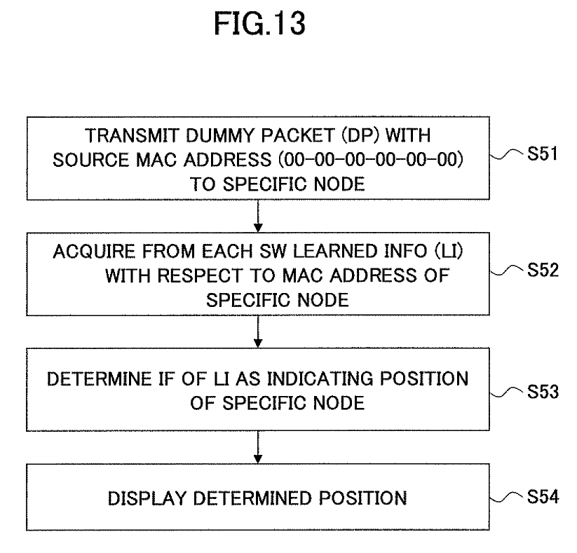

Hereafter, a node position search apparatus 10E according to Example 3 (for the second method) is described with reference to FIGS. 12 and 13.

In the node position search apparatus 10E of the present example, a packet output function unit 13E outputs a request packet (DP) to a specific node 200 such that the specific node 200 can return a response (RP) that behaves in a broadcast fashion (step S51). Thereafter, an information acquisition function unit 12E acquires learned information (LI) from each of SW-1(101) and SW-2(102) (step S52). Based on the thus acquired information, a node position analysis function unit 11E identifies the position of the specific node 200 (step S53). Then, the result is displayed by an analysis result display function unit 15 (step S54).

The above operation is described in detail with reference to FIG. 13.

In step S51, the node position search apparatus 10E transmits a unicast ARP request packet (DP) to the specific node 200, where the MAC address of the source of transmission is set to all zeros (i.e., “00:00:00:00:00:00”) in the packet. The specific node 200, each time it receives the ARP request packet (DP), returns an ARP response packet (RP) that has all zeroes as the destination MAC address to the node position search apparatus 10E.

Normally, an “all-zero” MAC address is not supposed to be learned by a switch operating on the L2 protocol. Therefore, each switch, upon reception of the packet having all zeroes as the destination MAC address, transfers the aforementioned ARP response packet (RP) in a broadcast fashion (i.e., by an unknown unicast). The request/response type packet transmitted in step S51 is not limited to the ARP packet as described above, but may comprise other request/response type packets.

In step S52, learned information (LI) (such as dot1dTpFdbPort MIB) concerning the MAC address of the specific node 200 is acquired from SW-1(101) and SW-2(102) by SNMP communications. In accordance with the present example, the learned information acquired indicates the interface No. 3 of SW-1(101) and also the interface No. 3 of SW-2(102).

This is due to the following fact. Namely, as depicted in FIG. 12, upon reception of the ARP response packet having all zeroes as the destination MAC address, each switch transfers the packet in a broadcast fashion. For example, SW-2(102) transfers the ARP response packet to both the node position search apparatus 10E and SW-1(101). As a result, SW-2(102), upon reception of the ARP response packet from the specific node 200, obtains the interface No. 3 connected to the specific node 200 as learned information. Similarly, SW-1(101), upon reception of the ARP response packet from SW-2(102), obtains the interface No. 3 connected to SW-2(102) as learned information.

In step S53, the interface number as the learned information of the specific node 200 in SW-1(101) and SW-2(102) is recognized as the interface number indicating the direction of the specific node 200.

In step S54, the direction of the interface with the number extracted from SW-1(101) and SW-2(102) is displayed as a position identification result.

### Example 4

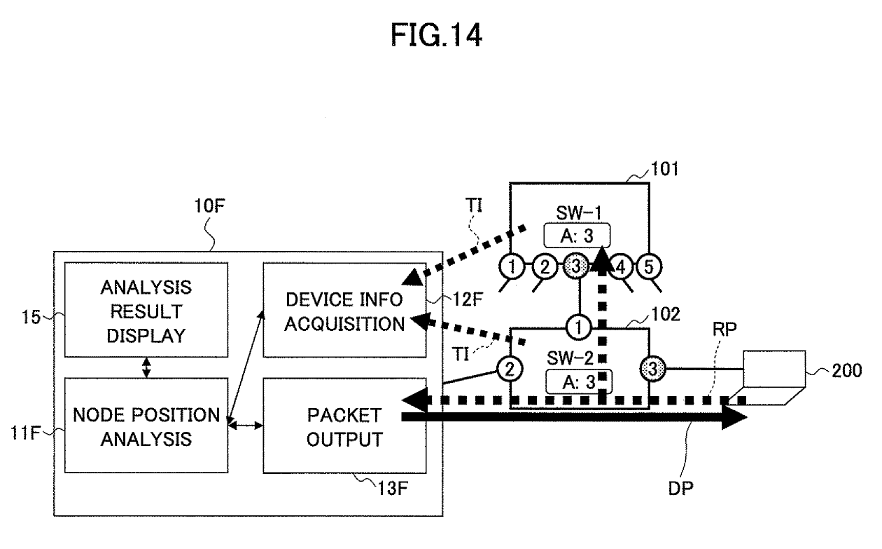

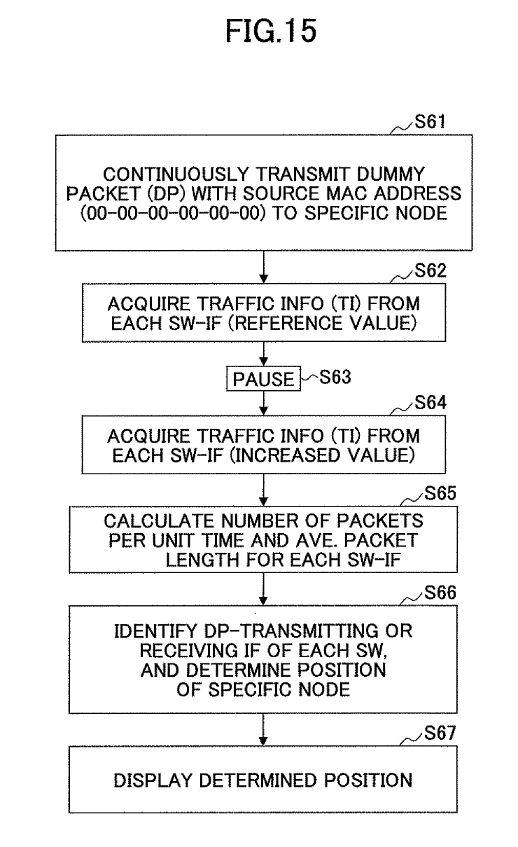

Hereafter, a node position search apparatus 10F according to Example 4 (for the second method) is described with reference to FIGS. 14 and 15. In the node position search apparatus 10F, a packet output function unit 13F keeps outputting a request packet (DP) to the specific node 200 so that the specific node 200 can return a response (RP) that behaves in a broadcast fashion (step S61). Then, as in the foregoing example, a device information acquisition function unit 12F acquires, from each interface of each switch, traffic information (TI) about the transmission/reception traffic volume and the number of transmitted/received packets twice (steps S62 and S64). From the difference in values between the two times of acquisition of the traffic information (TI), a node position analysis function unit 11F calculates a per-unit-time number of transmitted/received packets and an average transmitted/received packet length (step S65). Based on the resultant information, an analysis result display function unit 15 identifies the position of the specific node 200 (step S66), and displays the result (step S67).

FIG. 15 depicts a flowchart of the above operation.

In step S61, the node position search apparatus 10F keeps transmitting to the specific node 200 a unicast ARP request packet (DP) of a long size (such as 1500 bytes) that has all zeroes as the MAC address of the source of transmission, at a constant speed (such as 1000 pps).

The specific node 200, each time it receives the ARP request packet, returns an ARP response packet (RP) of a short size (64 bytes) to the “all zero” MAC address as a response to the node position search apparatus 10E.

Normally, a MAC address with “all zeroes” is not supposed to be learned by a switch operating on the L2 protocol. Thus, each switch, upon reception of the packet having “all zeroes” as the destination MAC address, transfers the ARP response packet in a broadcast fashion (i.e., by unknown unicast). The request/response type packet transmitted in step S61 is not limited to the above ARP packet but may comprise other types of request/response type packet.

In step S62, traffic information (TI) about the transmission/reception traffic volume (such as if OutOctets MIB and if InOctets MIB) and the transmitted/received packet counter value (such as if OutUcastPkts MIB and if InUcastPkts MIB) is acquired from SW-1(101) and SW-2(102) by SNMP communications. Because the values obtained here are accumulated value information since the startup of the system, they are used as reference values.

In step S63, a certain pause time (such as 5 seconds) is allowed to pass.

In step S64, information of the transmission/reception traffic volume (such as if OutOctets MIB and if InOctets MIB) and the transmitted/received packet counter value (such as if OutUcastPkts MIB and if InUcastPkts MIB) is again acquired by SNMP communications. The data obtained here is used as increased values.

In accordance with the present example, the transmission/reception counter of the interface No. 3 of SW-2(102) should exhibit values larger than the data acquired in step S62, due to the transmission/reception of the dummy request/response packet in step S61.

This is due to the fact, as in the case of Example 3, as depicted in FIG. 14, upon reception of the ARP response packet having all zeroes as the destination MAC address as described above, each switch transfers the packet in a broadcast fashion. For example, SW-2(102) transfers the ARP response packet to both the node position search apparatus 10F and SW-1(101).

As a result, in SW-2(102) that has received the ARP response packet from the specific node 200, the reception counter of the interface No. 3 connected to the specific node 200 increases. Similarly, in SW-1(101) that has received the ARP response packet from SW-2(102), the reception counter of the interface number 3 connected to SW-2(102) increases.

In step S65, from the information acquired in steps S62 and S64, a per-unit-time transmitted/received packet number (i.e., transmission/reception speed) and an average transmitted/received packet length are calculated.

In step S66, from the values calculated in step S65, a reception interface for the dummy response packet or a transmission interface for the dummy request packet is extracted from SW-1(101) and SW-2(102). The extraction method may involve determining whether the calculated value is within a range of threshold (such as 5%) of the output speed of the dummy request packet outputted in step S61 or the outgoing packet length.

In accordance with the present example, the interface No. 3 is extracted from both SW-1(101) and SW-2(102). Thus, by also considering the response packet reception interface, the direction of the interface indicating the position of the specific node 200 can be extracted from SW-1(101) as well, which is not located on the communication path between the node position search apparatus 10F and the specific node 200.

In step S67, the directions of the interfaces thus extracted from SW-1(101) and SW-2(102) are displayed as a position identification result.

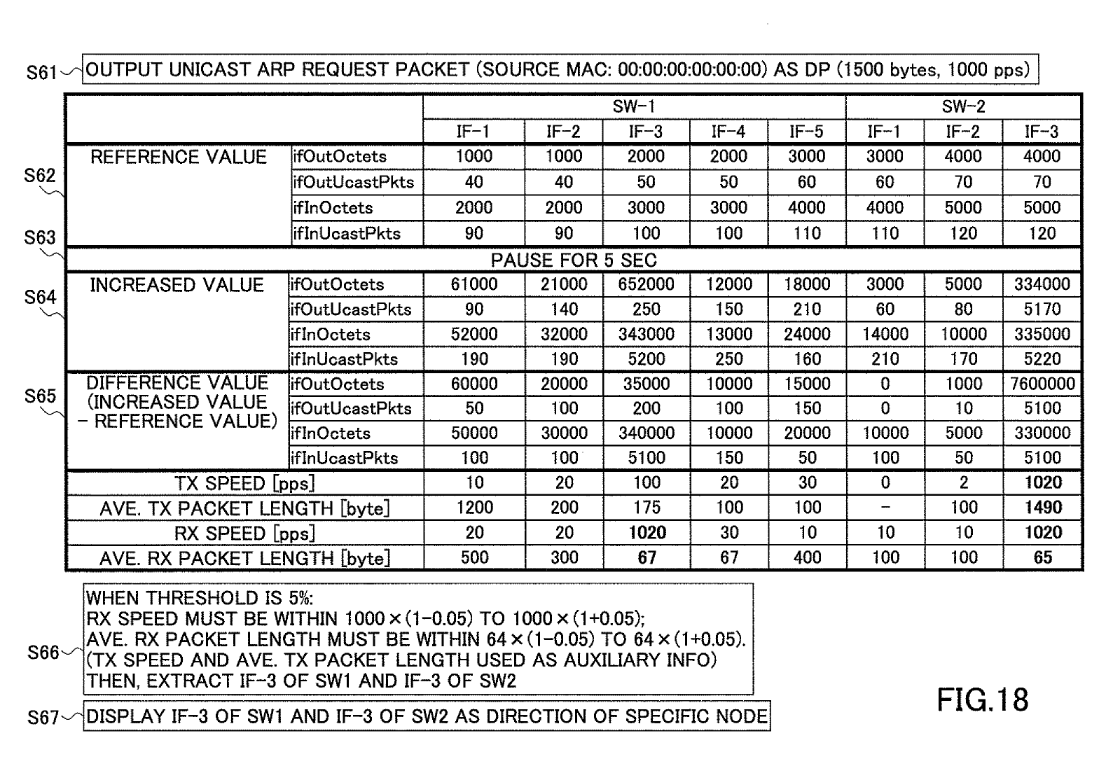

FIG. 18 depicts exemplary values in the case of Example 4. When a unicast ARP request packet (with the “all zeroes” MAC address of the source of transmission) of 1500 bytes is outputted at 1000 pps as the dummy packet in step S61, the traffic information of each switch obtained in the initial stage in step S62 indicates, as depicted in FIG. 18, for the interfaces Nos. 1 through 5 of SW-1(101), the transmission traffic volume (accumulated total) of 1000, 1000, 2000, 2000, and 3000, respectively; and the number of transmitted packets (accumulated total) of 40, 40, 50, 50, and 60, respectively. Similarly, for the interfaces Nos. 1 through 3 of SW-2(102), the transmission traffic volume (accumulated total) is 3000, 4000, and 4000, respectively; and the number of transmitted packets (accumulated total) is 60, 70, and 70, respectively.

For the interfaces Nos. 1 through 5 of SW-1(101), the reception traffic volume (accumulated total) is 2000, 2000, 3000, 3000, and 4000, respectively; and the number of transmitted packets (accumulated total) is 90, 90, 100, 100, and 110, respectively. Similarly, for the interfaces Nos. 1 through 3 of SW-2(102), the reception traffic volume (accumulated total) is 4000, 5000, and 5000, respectively; and the number of transmitted packets (accumulated total) is 110, 120, and 120, respectively.

Thereafter, in step S63, the pause time of 5 seconds is allowed to pass. In step S64, the traffic information of each switch for the next stage is obtained, which indicates, for the interfaces Nos. 1 through 5 of SW-1(101), the transmission traffic volume (accumulated total) of 61000, 21000, 652000, 12000, and 18000, respectively; and the number of transmitted packets (accumulated total) of 90, 140, 250, 150, and 210, respectively. Similarly, for the interfaces Nos. 1 through 3 of SW-2(102), the transmission traffic volume (accumulated total) is 3000, 5000, and 334000, respectively; and the number of transmitted packets (accumulated total) is 60, 80, and 5170, respectively.

For the interfaces Nos. 1 through 5 of SW-1(101), the reception traffic volume (accumulated total) is 52000, 32000, 343000, 13000, and 24000, respectively; and the received packet number (accumulated total) is 190, 190, 5200, 250, and 160, respectively. Similarly, for the interfaces Nos. 1 through 3 of SW-2(102), the reception traffic volume (accumulated total) is 14000, 10000, and 335000, respectively; and the received packet number (accumulated total) is 210, 170, and 5220, respectively.

In step S65, differences between steps S62 and S64 are determined. By dividing the difference in the number of transmitted packets by the pause time (5 seconds), a transmission speed (pps) is obtained. By dividing the difference value in the transmission traffic volume by the pause time (5 seconds), a per-unit-time transmission traffic volume is obtained. By further dividing the per-unit-time transmission traffic volume by the transmission speed (pps), an average transmission packet length can be obtained.

The transmission speed (pps) thus obtained for each interface of each switch is, as depicted in FIG. 18, 10, 20, 100, 20, and 30 pps for the interfaces Nos. 1 through 5, respectively, of SW-1(101); and 0, 2, and 1020 pps for the interfaces Nos. 1 through 3 of SW-2(102). Similarly, the average transmission packet length is 1200, 200, 175, 100, and 100 bytes for the interfaces Nos. 1 through 5, respectively, of SW-1(101); and unknown, 100, and 1490 bytes for the interfaces Nos. 1 through 3, respectively, of SW-2(102).

By dividing the difference in the numbers of transmitted packets by the pause time (5 seconds), a transmission speed (pps) can be obtained. Similarly, by dividing the difference value in the reception traffic volume by the pause time (5 seconds), a per-unit-time reception traffic volume can be obtained. By further dividing the per-unit-time reception traffic volume by the reception speed (pps), an average received packet length can be obtained.

Specifically, the reception speed is 20, 20, 1020, 30, and 10 pps for the interfaces Nos. 1 through 5, respectively, of SW-1(101); and 10, 10, and 1020 pps for the interfaces Nos. 1 through 3, respectively, of SW-2(102). Similarly, the average received packet length is 500, 300, 67, 67, and 400 bytes for the interfaces Nos. 1 through 5, respectively, of SW-1(101); and 100, 100, and 65 bytes for the interfaces Nos. 1 through 3, respectively, of SW-2(102).

Because the packet length of the dummy packet outputted in step S61 is 1500 bytes and the transmission speed is 1000 pps, the allowable range of the transmission packet length, when the aforementioned threshold is 5%, is 1500×0.95 to 1.05=1425 to 1575 bytes, while the allowable range of the transmission speed is 1000×0.95 to 1.05=950 to 1050 pps.

The size of the response packet is fixed to 64 bytes, as mentioned above. The response speed should be the same as the output speed, at 1000 pps. Thus, when the threshold is 5%, the allowable range of the received packet length is 64×0.95 to 1.05=60.8 to 67.2 bytes, while the allowable range of the reception speed is 1000×0.95 to 1.05=950 to 1050 pps. These conditions are satisfied by the 1490 bytes and 1020 pps of the interface No. 3 of SW-2(102) for transmission, and the 67 bytes and 1020 pps of the interface No. 3 of SW-1(101) or the 65 bytes and 1020 pps of the interface No. 3 of SW-2(102) for reception.

As a result, the interface No. 3 of SW-1(101) and the interface No. 3 of SW-2(102) are extracted (step S66).

In step S67, the interface No. 3 of SW-1(101) and the interface No. 3 of SW-2(102) are displayed as the directions indicating the position of the specific node 200.

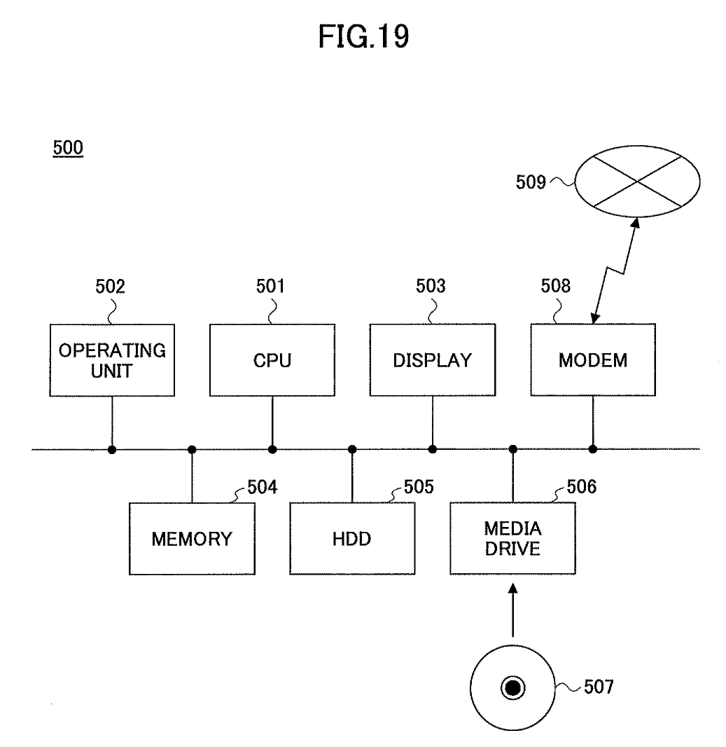

FIG. 19 depicts a block diagram of a computer 500 for realizing the node position search apparatus 10, 10A, 10B, 10C, 10D, 10E, or 10F of the foregoing embodiments and examples. As depicted, the computer 500 includes a CPU 501 for executing various operations in accordance with instructions described in a certain program; an operating unit 502, such as a keyboard and mouse, used by a user for entering an operation content of data or the like; a display unit 503, such as a CRT (cathode ray tube) or an LCD (liquid crystal display) unit, for displaying to the user a status or result of a process performed by the CPU 501; a memory 504 that may include a ROM (read-only memory) and a RAM (random access memory) for storing a program or data or the like used by the CPU 501 or providing a work area for the CPU 501; a hard disk drive 505 for storing a program or data or the like; a CD-ROM drive 506 for loading an external program or data via a CD-ROM 507; and a modem 508 for downloading a program, for example, from an external server via a communication network 509, such as the Internet or a LAN (local area network).

The computer 500 may load or download, via the CD-ROM 507 or the communication network 509, a program including instructions for causing the CPU 501 to execute one or more processes performed by each of the node position search apparatuses 10, 10A, 10B, 10C, 10D, 10E, and 10F. Such a program may be installed on the hard disk drive 505, loaded in the memory 504 as needed, and executed by the CPU 501, thus realizing each of the node position search apparatuses 10, 10A, 10B, 10C, 10D, 10E, and 10F with the computer 500.

Thus, the present invention has been described herein with reference to preferred embodiments thereof. While the present invention has been shown and described with particular examples, it should be understood that various changes and modification may be made to the particular examples without departing from the scope of the broad spirit and scope of the present invention as defined in the claims. That is, the scope of the present invention is not limited to the particular examples and the attached drawings.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. An information processing apparatus comprising:
a transmission unit configured to transmit a packet to a specific node as a communication target in a communication network; and
a node position determining unit configured to determine a position of the specific node by acquiring traffic information concerning the packet from a relaying device by which the packet is relayed in the communication network, analyzing the traffic information, and determining a flow of the packet with respect to the specific node.

2. The information processing apparatus according to claim 1, wherein the relaying device is configured to determine a direction of arrival of a packet at the relaying device upon relaying the packet in order to acquire learned information indicating a direction of a source of the packet, and configured to determine an output direction for relaying a packet addressed to the source, based on the learned information,
wherein the packet addressed to the specific node as the communication target is relayed by the relaying device in accordance with the output direction determined by the relaying device and arrives at the specific node.

3. An information processing apparatus comprising:
a request packet transmission unit configured to transmit a predetermined request packet to a specific node as a communication target in a communication network; and
a position acquisition unit configured to determine a position of the specific node by acquiring information for a flow of a return packet returned by the specific node upon reception of the predetermined request packet,
wherein the return packet is transferred by a relaying device by which the packet is relayed in the communication network in a broadcast manner.

4. The information processing apparatus according to claim 3, wherein the relaying device is configured to determine a direction of arrival of a packet at the relaying device upon relaying the packet in order to acquire learned information indicating a direction of a source of the packet, and configured to determine an output direction for relaying a packet addressed to the source, based on the learned information,
wherein the packet addressed to the specific node as the communication target is relayed by the relaying device in accordance with the output direction determined by the relaying device and arrives at the specific node.

5. The information processing apparatus according to claim 3, wherein the request packet has source information in which an address that is not to be learned by the relaying device upon relaying the request packet is set.
